(19) United States
(12) Patent Application Publication
(10) Pub. No.: US 2009/0279454 A1
(43) Pub. Date: Nov. 12, 2009

(54) METHOD FOR CONFIGURING A DHCP SERVER USING DHCP OPTION 82

(76) Inventors: Michael Wacker, Wannweil (DE); Markus Rentschler, Dettingen (DE); Dirk Mohl, Esslingen (DE); Oliver Kleineberg, Wendlingen (DE)

Correspondence Address: K.F. ROSS P.C., 5683 RIVERDALE AVENUE, SUITE 203 BOX 900, BRONX, NY, 10471-0900, US

(21) Appl. No.: 12/177,292

(22) Filed: Jul. 22, 2008

(30) Foreign Application Priority Data
Aug. 4, 2007 (DE) 102007036962.1

(51) Int. Cl. H04L 12/28

(52) U.S. Cl. 370/255

(57) ABSTRACT

The invention relates to a method for creating a DHCP network device configuration, wherein the parameter allocation by a DHCP server is performed using Option 82, and the assignment for the IP address to be allocated to a network device is determined on the basis of the topological information. The topological information is provided to the DHCP server by the requesting device and a DHCP relay agent, and the relay agent acts on each DHCP message sent by a device in the network by means of an additional DHCP Option 82 and sends the messages via unicast to the DHCP server, whereas the standard DHCP message is forwarded. According to the invention, a network device sends, in addition to the regular DHCP discovers via MAC broadcast, DHCP messages via MAC multicast to a MAC multicast address, and from this MAC multicast sends unique information via unicast to the DHCP server by means of a DHCP relay agent, since the associated network device filters the multicast. The creation of a DHCP server configuration is automated by use of a software component for the network management.

The invention relates to a method for creating a DHCP network device configuration according to the features of the preamble of claim 1.

In the prior art, parameters are allocated as a function of topology, using DHCP Option 82. DHCP stands for “Dynamic Host Configuration Protocol,” and is known as such.

If an infrastructure device fails in a network that is fully configured for DHCP Option 82, it is only necessary to replace it with an identical device. Further configuration is not required. Since the topology of the network, and therefore the topological information, has not changed, the replacement device receives the same IP address and the same parameters, using DHCP Option 82, as the prior defective device.

The allocation of IP parameters using DHCP Option 82 fundamentally differs from the traditional procedure in that the DHCP server establishes a fixed assignment between a physical, device-based unique attribute (for example, a Media Access Control (MAC) address) and an IP address to be allocated for the corresponding device.

Instead of tying the IP address that is to be allocated to a fixed, device-based attribute (such as the MAC address, for example), in the parameter allocation using Option 82 the assignment for the IP address to be allocated is determined on the basis of the topological information provided to the DHCP server by the requesting device and a DHCP relay agent.

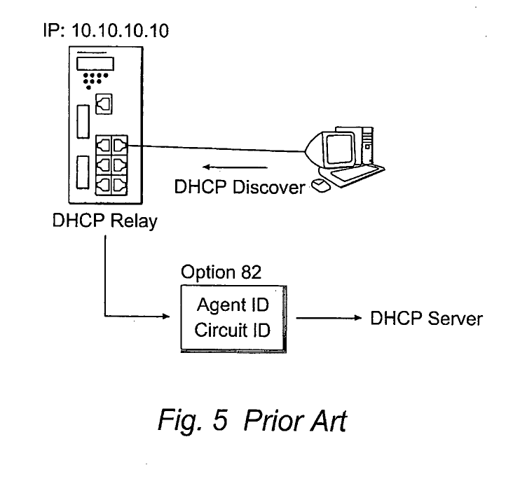

The DHCP relay agent is a software component that is present on the infrastructure devices present in the network topology, and must be activated. The relay agent acts on each DHCP message sent by a device in the network by means of an additional DHCP option, Option 82, and sends the messages via unicast to the DHCP server, whereas the standard DHCP message is forwarded in the customary manner (for example, one DHCP discover per broadcast; also see FIG. 5).

Thus, only assignments based on transmitted topological information result for the parameter allocation. The unique physical characteristics for a device (the MAC address, for example) are no longer relevant for the parameter allocation.

The programming of network devices such as, for example, Ethernet switches or the functionalities provided on the hardware side by the chipsets used does not permit filtering of MAC broadcasts for most Ethernet switches.

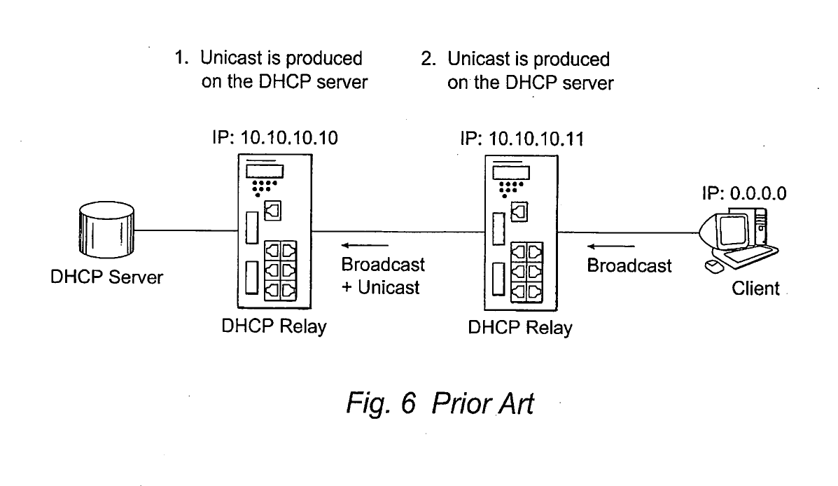

It is standard, for example, for an Ethernet switch to output a broadcast received at a port to all switch ports (except for the port at which the broadcast was received). This may result in ambiguities in the address allocation when the IP allocation is performed using DHCP Option 82 by means of relay agents (see FIG. 6).

In this case (FIG. 6) the client creates a DHCP message that is received at the first relay. At this location the broadcast is relayed, and is also acted on by Option 82 and its specific agent ID and circuit ID, and sent via unicast to the DHCP server. The relayed broadcast then arrives at another network device having an activated DHCP relay. Here as well, the agent evaluates the broadcast and sends a unicast, using Option 82 and its specific agent ID and circuit ID, to the DHCP server.

Both the first and the second unicast then arrive at the DHCP server. Thus, two different requests exist for the same device. Based on only the DHCP messages actually forwarded, the DHCP server is not able to determine which request is the correct request, and therefore an unambiguous assignment and IP address allocation is not possible. In addition, an incorrect allocation of IP addresses may occur when multiple devices and/or clients are located in one branch of a topology tree, and various DHCP messages arrive in the form of broadcasts at the same interface of an infrastructure device having an activated DHCP relay agent. For each broadcast the infrastructure device generates a unicast at the DHCP server, each with an identical agent ID and circuit ID. In this case as well, an unambiguous decision cannot be made as to which requesting device/client should be assigned the IP address.

The object of the invention, therefore, is to allow the configuration sequences for creation of a configured network to be automated and improved, and to allow an unambiguous assignment and IP address allocation.

This object is achieved by the features of claim 1.

According to the invention, a network device sends, in addition to the regular DHCP discovers via MAC broadcast, DHCP messages via MAC multicast to a MAC multicast address, and from this MAC multicast sends unique information via unicast to the DHCP server by means of the DHCP relay agent, so that the associated network device can filter the multicast.

Devices that are necessary for operation of the network, for example as a (central) switching unit, are referred to below as “devices,” “network devices,” or “infrastructure devices.” Examples of (infrastructure) devices are Ethemet switches or routers. Devices that are not necessary as active components for operation of the network but that use the provided network for productive operation are referred to below as “clients.” Examples of clients include notebooks, personal computers, or the control units for machines having Ethernet interfaces.

Approach for network devices (infrastructure devices within the network):

The network devices (infrastructure devices such as switches or the like) send, in addition to the regular DHCP discovers via MAC broadcast, DHCP messages via MAC multicast to a MAC multicast address. Multicast frames are usually treated as broadcast frames by Ethernet switches: the switches forward the multicast frames via all interfaces (except for the reception interface). However, a multicast frame at a particular multicast address is not forwarded by an infrastructure device that is specifically modified for this purpose, but instead is filtered.

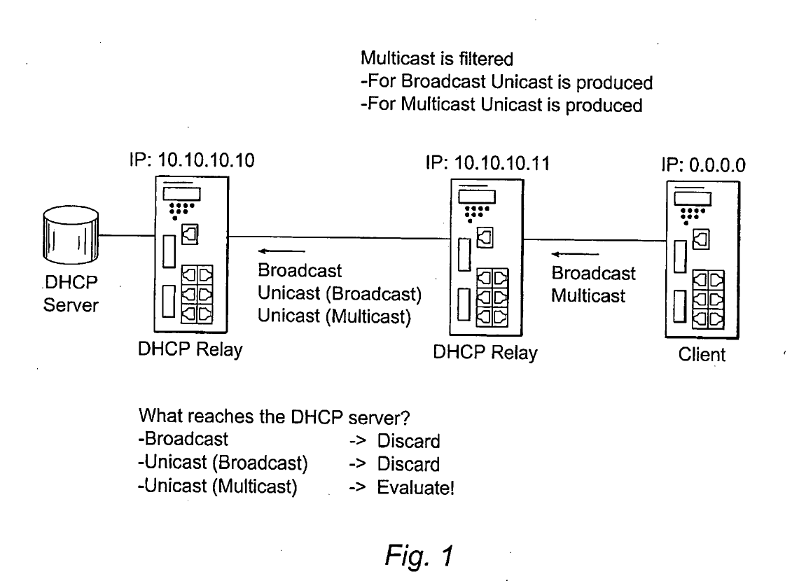

At the same time, the relay agent operating on this device generates another unicast from the multicast and sends it to the DHCP server. In the DHCP server configuration, only one entry, based on the incoming multicast forwarded by the agent, is generated for the requesting device, whereas the DHCP server does not respond to incoming broadcasts or unicasts based on these broadcasts. Only the incoming unicast generated from the multicast is uniquely assigned and therefore usable for the IP address allocation (see FIG. 1).

In addition, the relay agent prevents the unicast from being generated from the broadcast, which is discarded at the DHCP server anyway, thereby reducing the network load. The information concerning whether, on the basis of the broadcast, this unicast should be generated must be provided in the agent configuration on the infrastructure devices, and must be capable of being switched on and off.

Approach for clients:

Unlike the case for infrastructure devices, for clients the starting point cannot be a generated multicast frame. It is very likely that only DHCP messages via MAC broadcast are available to clients.

In order to provide unambiguity in such a situation, it must be ensured that clients are used only as the last device in a branch of a topology tree. In addition, the above-referenced prevention of generation of unicasts from broadcasts must be switched off at all ports of all infrastructure devices to which the clients are connected.

From the broadcast, the unicast generated by the first DHCP relay is then evaluated on the DHCP server for this client, using Option 82.

Manual determination of the agent ID and circuit ID parameters, and thus the correct generation of a configuration entry, is manageable for an end user only with a high level of administrative effort for each individual entry, with the assistance of documentation, and is also very susceptible to error. In order to design this system to be usable with a justifiable expenditure of resources, the processes for generating the entry, in particular the determination of the agent ID and circuit ID, must be automated to the greatest extent possible.

The objective of automated generation of the server configuration, therefore, is to enable configuration-free replacement of defective devices, using DHCP Option 82, without the user having to manually create an entire configuration for the DHCP server.

Therefore, the invention also provides a method for reading existing information and for automatically creating the configuration.

It must also be taken into account that for a new installation of management software that assists in automation, a network that is already partially or completely configured with IP addresses may be present. These environmental parameters must be evaluated, and an assisting software component must take this into consideration in the creation of the DHCP configuration.

To minimize the complexity of configuration for use of such a system in a network environment, the management system may receive the information that is relevant for generation of entries for the DHCP configuration from the devices that have already been provided with IP addresses.

To this end, the devices that have already been provided with an IP address are determined by use of a software component (which runs as a computer program product on a computer) for the network management (for example, Industrial HiVision from the applicant).

The infrastructure devices are then accessed via a management interface, for example Simple Network Management Protocol (SNMP), and the parameters necessary for entry in the DHCP configuration, such as the agent INFORMATION DISCLOSURE STATEMENT and circuit INFORMATION DISCLOSURE STATEMENT, among others, are determined.

Based on the information that is read, the management software is then able to create the DHCP configuration for the devices and to provide same to the DHCP server. Configuration-free replacement of defective devices is possible as soon as the newly created configuration and the DHCP server are available and active.

Also claimed is a method for self-supporting neighbor configuration for the allocation of parameters, using DHCP Option 82.

The self-supporting neighbor configuration provides for the automatic integration of new infrastructure devices into the existing network, i.e., the configuration of an entire newly created network for Option 82 IP allocation, without the user having to perform the complex determination of the required parameters necessary for this purpose.

As a prerequisite, at least one infrastructure device having a configured and activated DHCP relay agent is required upstream from the DHCP server, and this device must be manually set up before starting the neighbor configuration.

For configuration, it is necessary only for the user to provide the IP address(es), either permanently associated with a device or in the form of a pool (list), from which the addresses for the various infrastructure devices are selected.

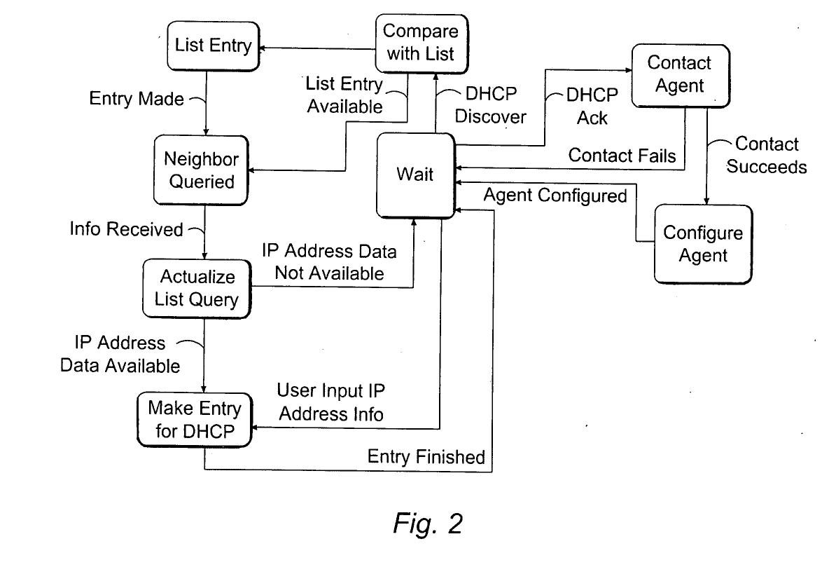

The individual steps have the following sequence (also see FIG. 2):

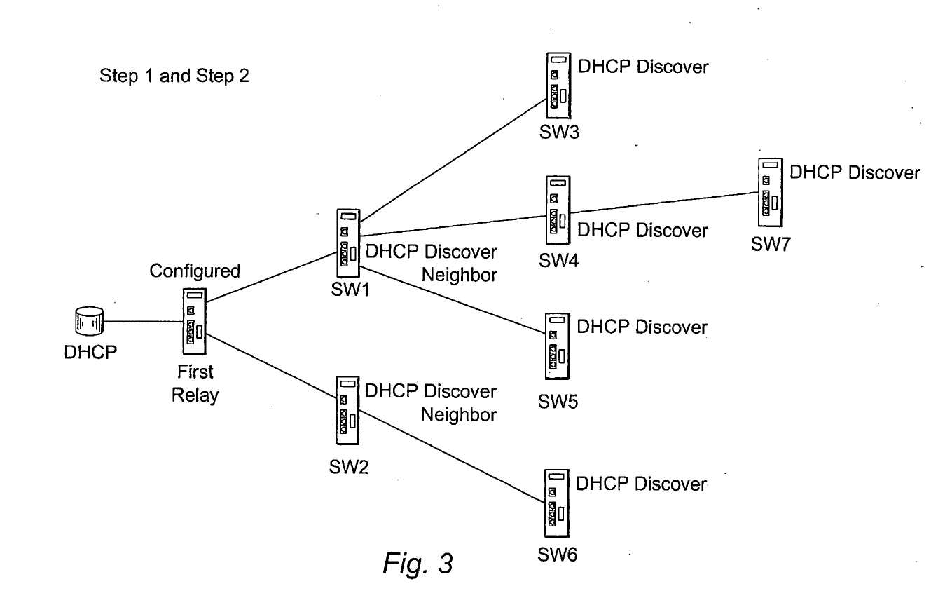

1. Each new device that reports on the network as a new device (for example, via a DHCP discover) is entered by the management software into a list for devices to be configured (see also FIG. 3, “DHCP discover” label);

2. By querying via a management interface (SNMP, for example) concerning the neighbor information available on the relay, using a discovery protocol (Link Layer Discovery Protocol (LLDP), for example), the neighbors directly connected to this relay are identified. These neighbors are labeled in the device list for the devices to be configured (see also FIG. 3, “Neighbor” labels at SW1 and SW2);

3. For the identified neighbors, entries are created for the DHCP configuration, based on the information that can be read by the agent via the management interface (for example, agent ID and circuit ID). As soon as information for the IP address that is to be allocated to the particular devices is present, the entry is completed and activated, and the DHCP server assigns an IP address;

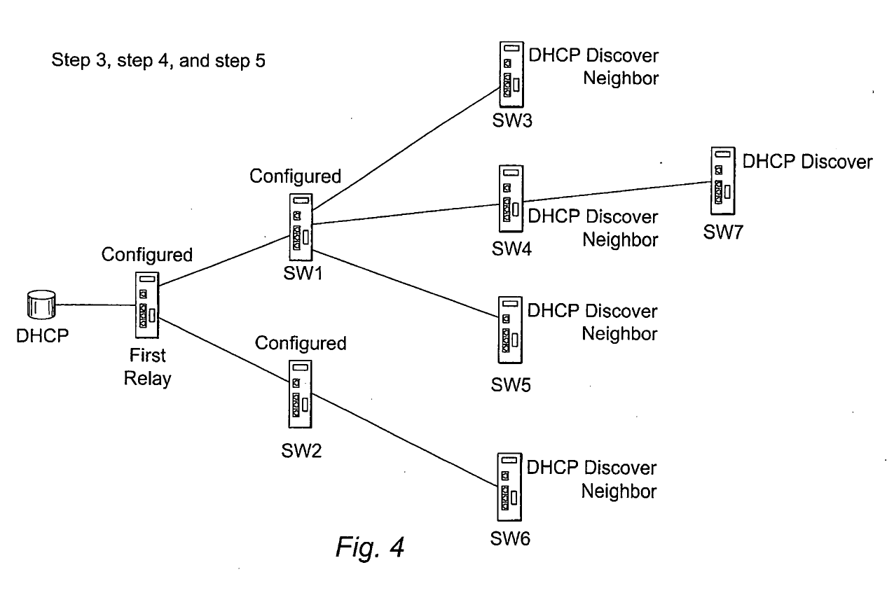

4. The DHCP relay agent is activated and configured on each device that has been newly configured with an IP address (in FIG. 4, at SW1 and SW2), provided that the device is an infrastructure device and has access to the corresponding software component;

5. The process starts over on each newly configured relay, beginning at step 1, until all unconfigured devices have been recognized and entries have been created.

It must also be ensured that in a meshed network or ring topology all possible configuration entries have been identified for a device when redundant paths are available. After all network subscribers have been identified, this may be achieved by once again checking, via the management interface, all infrastructure devices for entries that have not been identified by the neighbor configuration.

One example of an application scenario is a production room containing several machines that are provided with control information via an industrial Ethernet network and the associated infrastructure devices. If, for example, an infrastructure device fails during the night shift due to a defect, the defective device must be replaced as soon as possible to prevent a lengthy and costly production shutdown. This may have to be performed by an employee on the night shift. If the configuration of the infrastructure devices has been implemented using DHCP Option 82, the employee only has to remove the defective switch from the topology and replace it with an identical, unconfigured new device. All further necessary initial steps on the network management level, such as IP allocation and transfer of DHCP options for the configuration, are performed by the DHCP server. The employee who is replacing the device does not require access to the network management systems or specialized training. On the other hand, if the IP allocation and configuration have not been performed using DHCP Option 82, for the changes in the topology and at the management level the employee needs appropriate training and access to the interfaces relevant to the exchange, for example the manual DHCP server configuration, in order to update the parameters that have been altered as a result of the exchange that may also be very time-consuming.

1. A method for creating a DHCP network device configuration in which
the parameter allocation by a DHCP server is performed using Option 82 and
the assignment for the IP address to be allocated to a network device is determined on the basis of the topological information,
the topological information being provided to the DHCP server by the requesting device and a DHCP relay agent, and
the relay agent acts on each DHCP message sent by a device in the network by means of an additional DHCP Option 82 and sends the messages via unicast to the DHCP server, whereas the standard DHCP message is forwarded wherein
a network device sends, in addition to the regular DHCP discovers via MAC broadcast, DHCP messages via MAC multicast to a MAC multicast address, and from this MAC multicast sends unique information via unicast to the DHCP server by means of the DHCP relay agent so that the associated network device can filter the multicast.

2. The method according to claim 1 wherein the network device is a terminal, and the terminal is used as the last device in a branch of a topology tree, wherein in addition the prevention of generation of unicasts from broadcasts is switched off at all ports of all network devices to which the terminals are connected, and from the broadcast the unicast generated by the first DHCP relay is then evaluated on the DHCP server for this device, using Option 82.

3. The method according to claim 1 that wherein the information that is relevant for generation of entries for the DHCP configuration is read from the network devices that have already been provided with IP addresses.

4. The method according to claim 1 wherein the network devices that have already been provided with an IP address are determined by use of a software component for the network management, and the network devices are then accessed via a management interface and the parameters necessary for entry in the DHCP configuration are determined, and based on the information that is read the management software then creates the DHCP configuration for the devices and provides same to the DHCP server.

5. The method according to claim 4 wherein the management interface is Simple Network Management Protocol (SNMP).

6. The method according to claim 1 wherein a first network device having a configured and activated DHCP relay agent that has been manually set up before starting a neighbor configuration is provided upstream from the DHCP server, and a user provides the IP address(es) for the configuration.

7. The method according to claim 1 wherein the DHCP server configuration is created in steps, using a software component for the network management, according to the following sequence:
each new device that reports on the network as a new device (for example, via a DHCP discover) is entered by the management software into a list for devices to be configured;
by querying via a management interface concerning the neighbor information available on the relay, using a discovery protocol, the neighbors directly connected to this relay are identified, and these neighbors are labeled in the device list for the devices to be configured;
for the identified neighbors, entries are created for the DHCP configuration, based on the information that is read by the agent via the management interface, and as soon as this information for the IP address that is to be allocated to the particular devices is present, the entry is completed and activated, and the DHCP server assigns an IP address;
the DHCP relay agent is activated and configured on each device that has been newly configured with an IP address, provided that the device is an infrastructure device and has access to the corresponding software component;
the process starts over on each newly configured relay, beginning at step 1, until all unconfigured devices have been recognized and entries have been created.

8. The method according to claim 6 wherein the at least one IP address is either permanently associated with a network device, or is present in a pool from which the IP addresses for the various network devices are selected.
